(19) United States
(12) Patent Application Publication
(10) Pub. No.: US 2024/0113345 A1
(43) Pub. Date: Apr. 4, 2024

(54) BATTERY MODULE AND SHORT PROTECTION METHOD THEREOF

(71) Applicant: ASUSTeK COMPUTER INC., Taipei City (TW)

(72) Inventors: Chunyen Lai, Taipei City (TW); Yu-Cheng Shen, Taipei City (TW); Chun Tsao, Taipei City (TW); Chaochan Tan, Taipei City (TW); Huichuan Lo, Taipei City (TW); Wen-Che Chung, Taipei City (TW); Ming Hung Yao, Taipei City (TW)

(73) Assignee: ASUSTeK COMPUTER INC., Taipei City (TW)

(21) Appl. No.: 18/322,572

(22) Filed: May 23, 2023

(30) Foreign Application Priority Data
Sep. 29, 2022 (TW) 111136992

(51) Int. Cl. H01M 10/44; H01M 10/42; H01M 10/48; H02J 7/00

(52) U.S. Cl. CPC H01M 10/443; H01M 10/425; H01M 10/486; H02J 7/0032; H01M 2010/4271; H01M 2200/10

(57) ABSTRACT

A battery module and a short protection method thereof are provided. The battery module has a battery cell pack and a control circuit. The method includes: detecting a temperature of the battery cell pack as a battery cell temperature through the control circuit; determining whether the battery cell temperature shows a downward trend when the battery cell temperature is higher than a first predetermined temperature value; and deactivating the battery module when the battery cell temperature does not show the downward trend.

### CROSS-REFERENCE TO RELATED APPLICATION

This application claims the priority benefit of Taiwan application serial no. 111136992, filed on Sep. 29, 2022. The entirety of the above-mentioned patent application is hereby incorporated by reference herein and made a part of this specification.

### BACKGROUND

### Technical Field

The disclosure relates to a battery module and a short protection method thereof.

### Description of Related Art

Most of today's consumer electronic devices (e.g., desktop computers, notebook computers, mobile phones, digital cameras, tablet computers) are assembled with battery modules that may be charged/discharged. When the internal structure of the battery cell in the battery pack is damaged due to external impact or an abnormal production process, the battery cell is prone to micro-short. At this time, if the battery module is continuously charged or discharged, the battery cell temperature rises sharply (up to 100 degrees or more), and self-combustion will cause safety problems.

The early onset of the micro-short is a slight increase in battery temperature. However, the existing protection mechanism cannot effectively distinguish whether the temperature rise is caused by a short inside the battery cell or by the chemical reaction inside the battery during the general charge/discharge process, making it difficult to effectively detect the micro-short, leading to increased danger.

### SUMMARY

The disclosure provides a short protection method suitable for a battery module including a battery cell pack and a control circuit. The method includes: detecting a temperature of the battery cell pack as a battery cell temperature through the control circuit; determining whether the battery cell temperature shows a downward trend when the battery cell temperature is higher than a first predetermined temperature value; and deactivating the battery module when the battery cell temperature does not show the downward trend.

The disclosure also provides a battery module including a battery cell pack and a control circuit. The control circuit is coupled to the battery cell pack. The control circuit is configured to: detect a temperature of the battery cell pack as a battery cell temperature; determine whether the battery cell temperature shows a downward trend when the battery cell temperature is higher than a first predetermined temperature value; and deactivate the battery module when the battery cell temperature does not show the downward trend.

Based on the above, the battery module and a short protection method thereof of the disclosure may effectively distinguish that the temperature rise is caused by a micro-short phenomenon inside the battery cell and may activate the short protection immediately to avoid the occurrence of safety problems and reduce the danger.

In order to make the aforementioned features and advantages of the disclosure more comprehensible, embodiments accompanied with figures are described in detail below.

### BRIEF DESCRIPTION OF THE DRAWINGS

FIG. 1 is a block diagram of a battery module according to an embodiment of the disclosure.

FIG. 2 is a flowchart showing a short protection method according to an embodiment of the disclosure.

FIG. 3A and FIG. 3B are examples of battery cell temperatures drawn in accordance with an embodiment of the disclosure.

### DESCRIPTION OF THE EMBODIMENTS

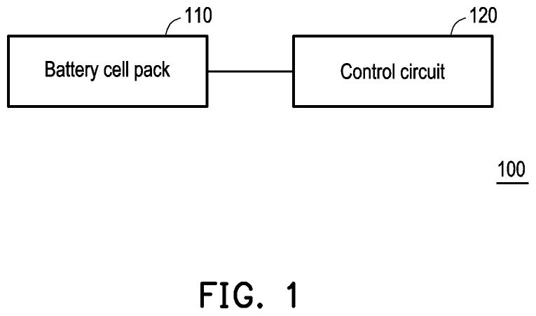

Referring to FIG. 1, the battery module 100 of the embodiment includes a battery cell pack 110 and a control circuit 120. The battery cell pack 110 is formed by, for example, single or multiple battery cells (battery cell monomer). The control circuit 120 is coupled to the battery cell pack 110. The control circuit 120 includes, for example, a battery gauge IC, which may detect the status of the battery cell pack 110 such as stored power, temperature, and charge/discharge current.

The control circuit 120 of the embodiment may effectively activate a short protection in the early stage of a micro-short phenomenon in the battery cell pack 110, thereby avoiding the occurrence of safety problems. An embodiment is provided hereinafter to elaborate the short protection method of the disclosure.

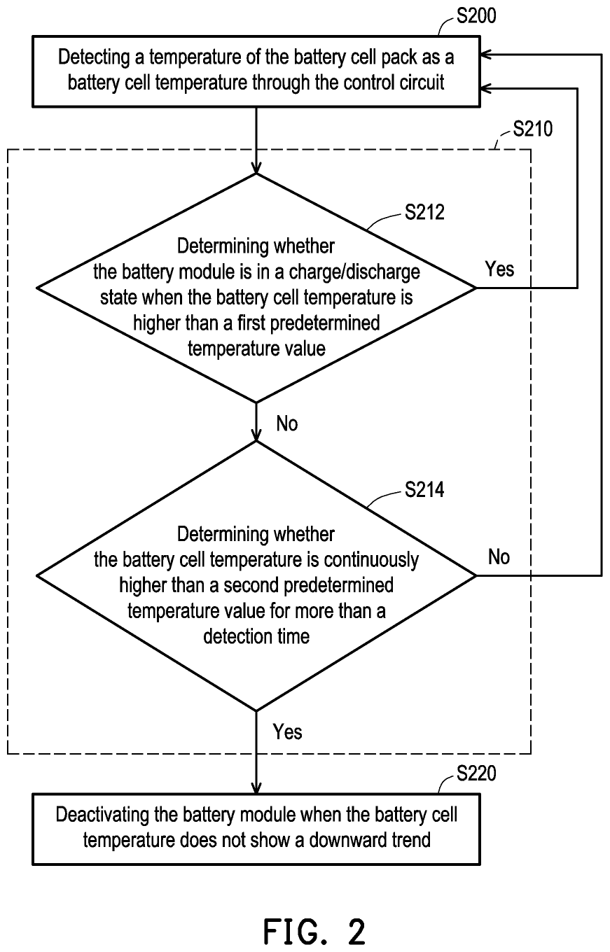

Referring to FIG. 1 and FIG. 2 at the same time, the method of this embodiment may be applied to the battery module 100 of FIG. 1, and the steps are described as follows.

First, during normal operation (e.g., general charge/discharge) of the battery cell pack 110, in step S200, the control circuit 120 detects a temperature of the battery cell pack 110 as a battery cell temperature. Next, in step S210, to determine whether the battery cell temperature shows a downward trend when the battery cell temperature is higher than a first predetermined temperature value TP1.

The detailed process of determining whether the battery cell temperature shows the downward trend are described in step S212 and step S214. In step S212, the control circuit 120 determines whether the battery module 100 is in a charge/discharge state. If so, return to step S200 and continue to perform the step of detecting the battery cell temperature. If not, proceed to step S214.

In step S214, the control circuit 120 determines whether the battery cell temperature is continuously higher than a second predetermined temperature value TP2 for more than a detection time Dt. If so, it means that the battery cell temperature of the battery cell pack 110 does not show a normal decrease and then proceed to step S220. If not, it means that the battery cell temperature of the battery cell pack 110 shows a normal decrease and then return to step S200 and continue to perform the step of detecting the battery cell temperature. In this embodiment, the second predetermined temperature value TP2 is less than the first predetermined temperature value TP1. Those skilled in the art may adjust the first predetermined temperature value TP1 and the second predetermined temperature value TP2 according to the teaching of the disclosure and depending on the characteristics and requirements of the actual battery cell pack. The detection time Dt may be set to, for example, about 20 minutes, but the disclosure is not limited thereto.

Lastly, in step S220, to deactivate the battery module 100 when the battery cell temperature does not show the downward trend. Specifically, when the battery module 100 is not in the charge/discharge state and the battery cell temperature continues to be higher than the second predetermined temperature value TP2 for more than the detection time Dt, it means that the micro-short phenomenon occurs in the battery cell pack. Therefore, the control circuit 120 may deactivate the entire battery module 100. For example, the control circuit 120 may permanently turns off a power transistor in the battery module 100 for controlling a current transmission of the battery cell pack 110, so that the system is no longer able to perform any charge/discharge action on the battery cell pack 110.

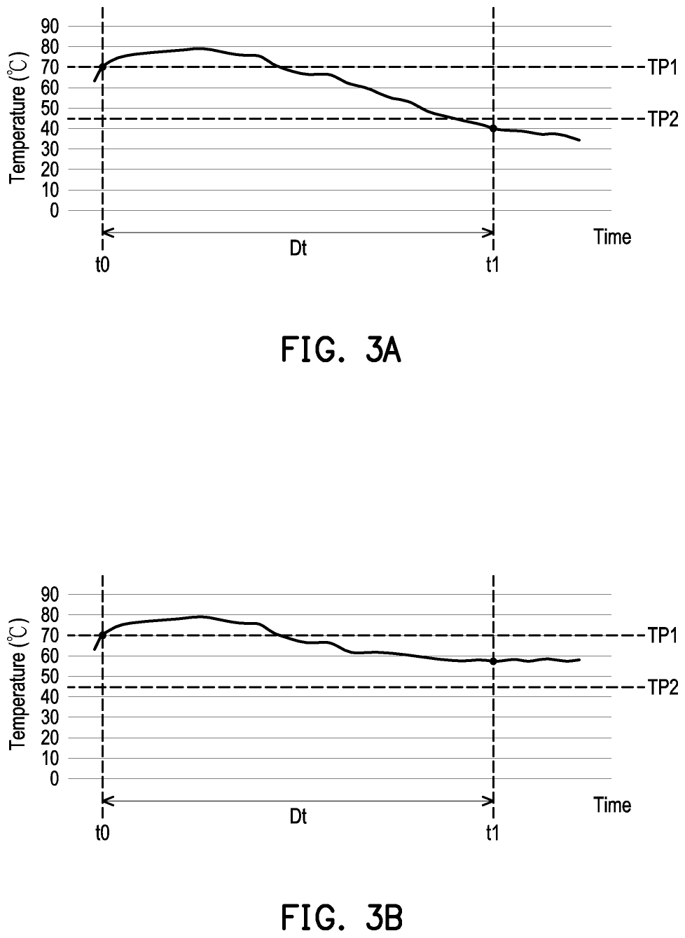

An example of the battery cell temperature is described below. In FIG. 3A and FIG. 3B, the horizontal axis shows a time and the vertical axis shows a battery cell temperature. FIG. 3A shows an example of a decreasing curve of battery cell temperature under normal conditions. FIG. 3B shows an example of a decreasing curve of battery cell temperature when the micro-short phenomenon occurs.

In FIG. 3A, the curve of the battery cell temperature is higher than the first predetermined temperature value TP1 from a time point t0. At this time, when not in the charge/discharge state, a normal battery cell temperature gradually decreases. As shown in FIG. 3A, after the detection time Dt has elapsed, the curve of the battery cell temperature is lower than the second predetermined temperature value TP2 at a time point t1. In this way, the battery cell pack is functioning normally, and there is no need to activate the short protection of the battery cell.

On the other hand, in FIG. 3B, the curve of the battery cell temperature is higher than the first predetermined temperature value TP1 from a time point t0. At this time, when not in the charge/discharge state, the temperature of the battery cell where the micro-short phenomenon occurs does not decrease or appears to decrease too slowly. As shown in FIG. 3B, after the detection time Dt has elapsed, the curve of the battery cell temperature is still higher than the second predetermined temperature value TP2 at a time point t1. In this way, the micro-short phenomenon has occurred in the battery cell pack, and there is a need to activate the short protection of the battery cell.

To sum up, the battery module and the short protection method of the battery cell of the disclosure may effectively detect an occurrence of the micro-short phenomenon in the early stage and activate a short protection immediately, thereby avoiding the occurrence of safety problems and reduce the danger.

What is claimed is:

1. A short protection method, suitable for a battery module comprising a battery cell pack and a control circuit, the method comprising:
detecting a temperature of the battery cell pack as a battery cell temperature through the control circuit;
determining whether the battery cell temperature shows a downward trend when the battery cell temperature is higher than a first predetermined temperature value; and
deactivating the battery module when the battery cell temperature does not show the downward trend.

2. The short protection method according to claim 1, wherein determining whether the battery cell temperature shows the downward trend comprises:
determining whether the battery module is in a charge/discharge state; and
determining whether the battery cell temperature is continuously higher than a second predetermined temperature value for more than a detection time when the battery module is not in the charge/discharge state.

3. The short protection method according to claim 2, wherein deactivating the battery module when the battery cell temperature does not show the downward trend comprises:
deactivating the battery module when the battery module is not in the charge/discharge state and the battery cell temperature is continuously higher than the second predetermined temperature value for a time exceeding the detection time.

4. The short protection method according to claim 2, wherein the second predetermined temperature value is less than the first predetermined temperature value.

5. The short protection method according to claim 1, wherein deactivating the battery module comprises:
permanently turning off a power transistor in the battery module for controlling a current transmission of the battery cell pack.

6. A battery module, comprising:
a battery cell pack; and
a control circuit, coupled to the battery cell pack, wherein the control circuit is configured to:
detect a temperature of the battery cell pack as a battery cell temperature;
determine whether the battery cell temperature shows a downward trend when the battery cell temperature is higher than a first predetermined temperature value; and
deactivate the battery module when the battery cell temperature does not show the downward trend.

7. The battery module according to claim 6, wherein the control circuit determines whether the battery module is in a charge/discharge state and
the control circuit determines whether the battery cell temperature is continuously higher than a second predetermined temperature value for more than a detection time when the battery module is not in the charge/discharge state.

8. The battery module according to claim 7, wherein the control circuit deactivates the battery module when the battery module is not in the charge/discharge state and the battery cell temperature is continuously higher than the second predetermined temperature value for a time exceeding the detection time.

9. The battery module according to claim 7, wherein the second predetermined temperature value is less than the first predetermined temperature value.

10. The battery module according to claim 6, wherein the control circuit permanently turns off a power transistor in the battery module for controlling a current transmission of the battery cell pack when the battery cell temperature does not show the downward trend.
